(19) United States
(12) Patent Application Publication
(10) Pub. No.: US 2006/0105814 A1
(43) Pub. Date: May 18, 2006

(54) Telephone apparatus

(76) Inventors: Takao Monden, Kanagawa (JP); Hazuki Yokose, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/518,192

(22) PCT Filed: May 23, 2003
(86) PCT No.: PCT/JP03/06481

§ 371 Date: Dec. 12, 2005

(30) Foreign Application Priority Data
Jun. 19, 2002 (JP) 2002-17887

(51) Int. Cl. H04M 1/00

(52) U.S. Cl. 455/566

(57) ABSTRACT

It is an object of the present invention to provide a portable telephone in which a display portion can be used as a mirror and electric power can be saved under a key locked state. In the telephone according to the present invention, in a front surface of a display portion (10), a panel (8) that is brought into a transparent state when voltage is not applied thereto, and is brought into a mirror surface state when voltage is applied is arranged. When the telephone is set to a key locked state, the panel (8) is brought to the mirror surface state and the display of the display portion (10) is turned off. Under a specific condition that, for instance, a call is received in the key locked state, the panel (8) can be suitably brought to the transparent state and the display of the display portion (10) can be turned on. Under a key unlocked state, while any key is operated, at least the panel (8) is brought to the transparent state and the display of the display portion (10) is turned on. When the key is not operated for a prescribed time, the panel (8) is brought to the mirror surface state and the display of the display portion (10) is turned off.

### TECHNICAL FIELD

The present invention relates to a telephone including a portable telephone, a simplified portable telephone, a portable information terminal device (PDA) and a fixed telephone.

### BACKGROUND ART

In recent years, a portable telephone having a mirror provided on the surface of a telephone main body has been devised by taking the utility of a user into consideration. As the portable telephone of this type, for instance, JP-A-2000-196718 discloses a portable telephone in which the front surface part of a main body of the portable telephone is formed as a mirror surface part, a part of the mirror is formed with a half-mirror, a liquid crystal display portion is provided in the back of the half-mirror, and when a back light of the liquid crystal display portion is turned off, all the mirror surface part including the half-mirror part acts as a mirror and when the back light is turned on, the display of the liquid display portion is seen through the half-mirror. Further, JP-A-2000-299719 also discloses a portable telephone in which a half-mirror is provided in the display surface side of a liquid display portion like the portable telephone disclosed in the above-described publication.

However, in the above-described technique, when the back light of the liquid crystal display portion is turned off, the mirror surface part functions as a mirror and the display of the liquid crystal display portion can be recognized only when the back light of the liquid crystal display portion is turned on. Accordingly, when the liquid crystal display portion displays information, both the liquid crystal display portion and the back light necessarily needs to be turned on. Thus, the consumption of electric power is increased, so that a telephone having a battery as a power source has been inconveniently hardly used for a long time.

Further, ordinarily, in the portable telephone, what is called a key lockup state can be frequently set in which a key cannot be operated without a specific key operation (a depression of an exclusive button, etc.) or under conditions other than a specific condition (at the time of receiving a call or receiving a mail). Since the key lockup state is set so that an erroneous operation does not occur when the portable telephone is not used, the liquid crystal display portion is rarely recognized under this state. However, even under the key lockup state, any illustration or date information has been hitherto displayed on the liquid crystal display portion even under the key lockup state. Accordingly, the liquid crystal display portion has been always kept turned on (ON). When the technique disclosed in the above-described two publications is directly applied to the usual portable telephone, not only the liquid crystal display portion, but also the back light needs to be always turned on to display information on the liquid crystal display portion. Thus, in the key lockup state, the consumption of electric power is undesirably increased.

It is an object of the present invention to solve the usual problems as described above and provide a portable telephone that has a function as a mirror and can reduce the consumption of electric power under a key locked state.

### DISCLOSURE OF THE INVENTION

A telephone according to the present invention includes: a display portion; a panel provided in a display surface side of the display portion and changing from a transparent state to a mirror surface state when voltage is applied thereto; and a control unit for bringing the panel to the mirror surface state and turning off the power of the display portion when a key locked state is set.

According to this structure, under the key locked state in which the display portion does not need to display information, the panel can be used as a mirror. Since the display portion is also turned off, the consumption of electric power can be reduced.

Further, the telephone according to the present invention further includes a second control unit for bringing the panel to the transparent state and turning on the power of the display portion when a call is received under the key locked state.

According to this structure, when the call is received even in the key locked state, the panel becomes the transparent state to display who sends the call on the display portion. Accordingly, a user can recognize it through the panel.

Further, the telephone according to the present invention further includes a third control unit for bringing the panel to the mirror surface state and turning off the power of the display portion when there is a response to the received call.

According to this structure, when the user responds to the received call to speak thereto under the key locked state, the user does not need to recognize the display of the display portion during speaking. Thus, the panel is brought to the mirror surface state and the power of the display portion is turned off so that the consumption of electric power can be reduced.

Further, in the telephone according to the present invention, the second control unit is provided for bringing the panel to the transparent state and turning on the power of the display portion when there is unrecognized call receiving history information or an unrecognized receiving mail under the key locked state.

According to this structure, when there is the unrecognized call receiving history information or the unrecognized receiving mail under the key locked state, the panel is brought to the transparent state and the power of the display portion is turned on. Accordingly, even when there is the unrecognized call receiving history information or the unrecognized receiving mail under the key locked state, contents displayed on the display portion can be recognized through the panel.

Further, in the telephone according to the present invention, the third control unit is provided for bringing the panel to the mirror surface state and turning off the power of the display portion after the unrecognized call receiving history information or the unrecognized receiving mail is recognized.

According to this structure, when the unrecognized call receiving history information or the unrecognized receiving mail is recognized under the key locked state, the panel is brought to the mirror surface state and the power of the display portion is turned off. Accordingly, the consumption of the electric power can be reduced.

### BRIEF DESCRIPTION OF THE DRAWINGS

FIG. 1 is a schematic block diagram of a portable telephone in an embodiment of the present invention.

FIG. 2 is a front view of an external appearance of the portable telephone according to the embodiment of the present invention.

FIG. 3 is a sectional view taken along a line A-A of a display portion and a panel part of the portable telephone shown in FIG. 2.

FIG. 4 is a flow chart for explaining the operation of the portable telephone according to the embodiment of the present invention.

FIG. 5 is a flow chart for explaining the operation of the portable telephone according to the embodiment of the present invention.

In the drawings, reference numeral 1 designates an antenna. 2 designates a transmitting and receiving part. 3 designates a key operating part. 4 designates a speaker. 5 designates a microphone. 6 designates a receiver. 7 designates a memory. 8 designates a panel. 9 designates a panel control part. 10 designates a display portion. 11 designates a display portion control part. 12 designates a central control part.

### BEST MODE FOR CARRYING OUT THE INVENTION

Now, an embodiment of the present invention will be described below by referring to the drawings. In the embodiment, as a telephone including a portable telephone, a simplified portable telephone, a portable information terminal device (PDA), and a fixed telephone, the portable telephone is described as an example.

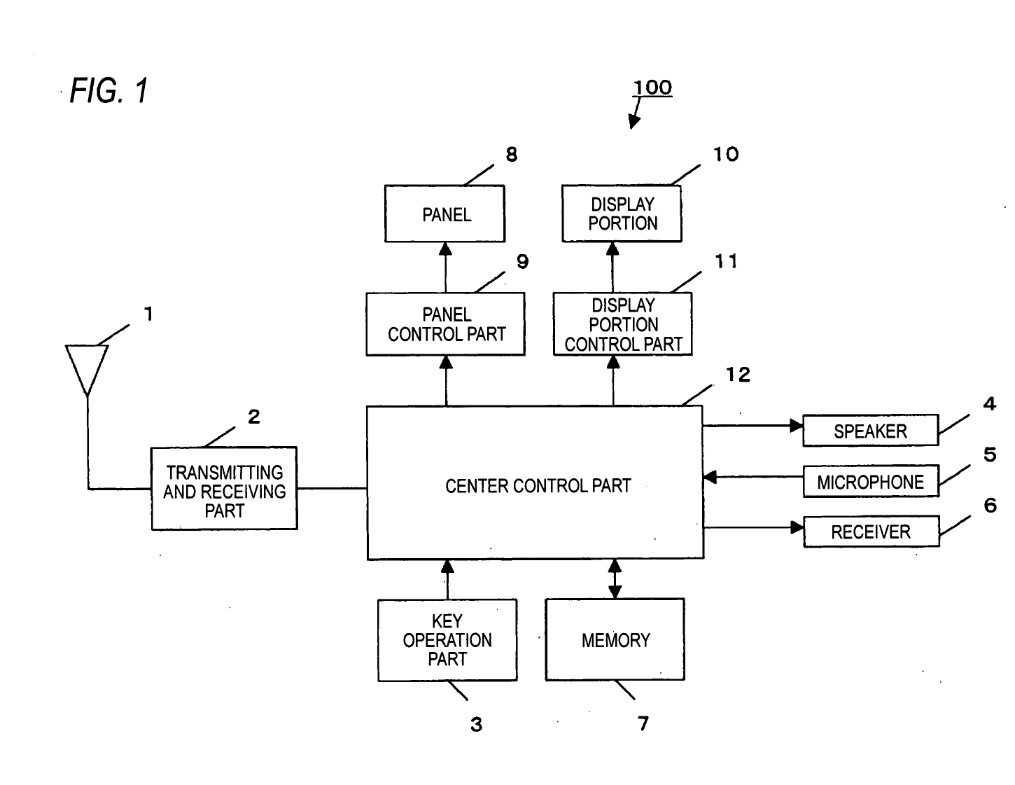

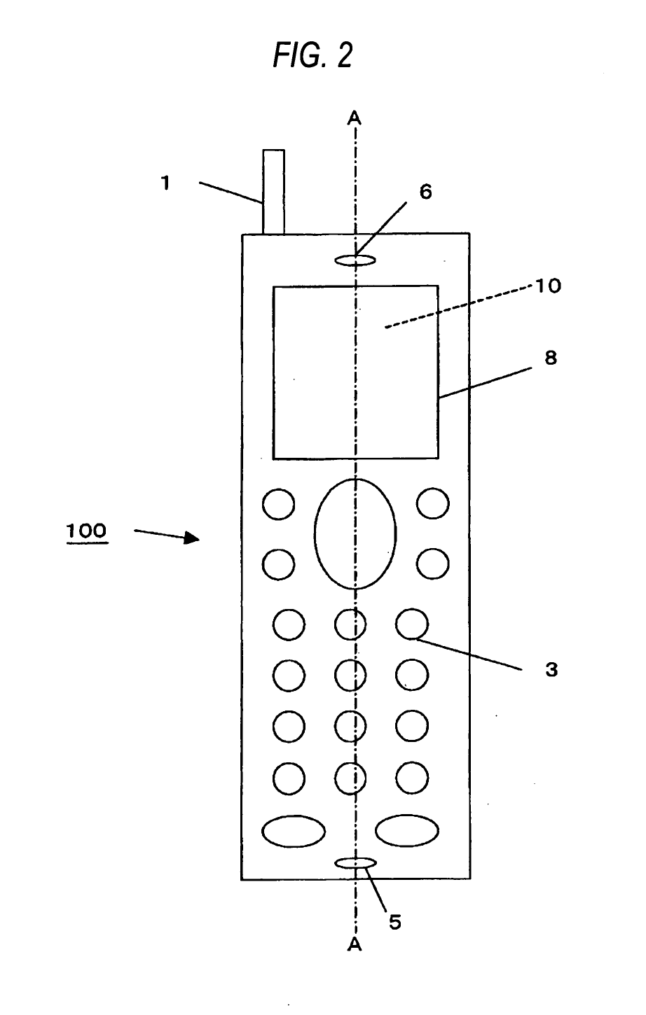

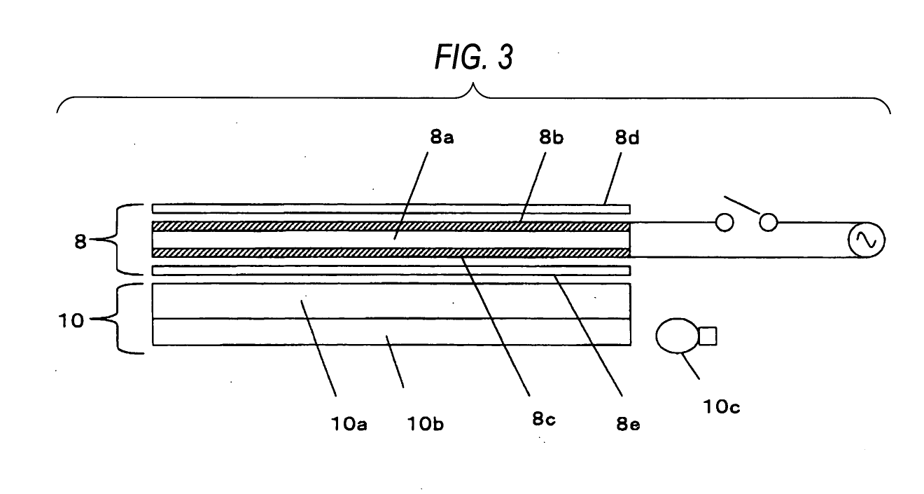

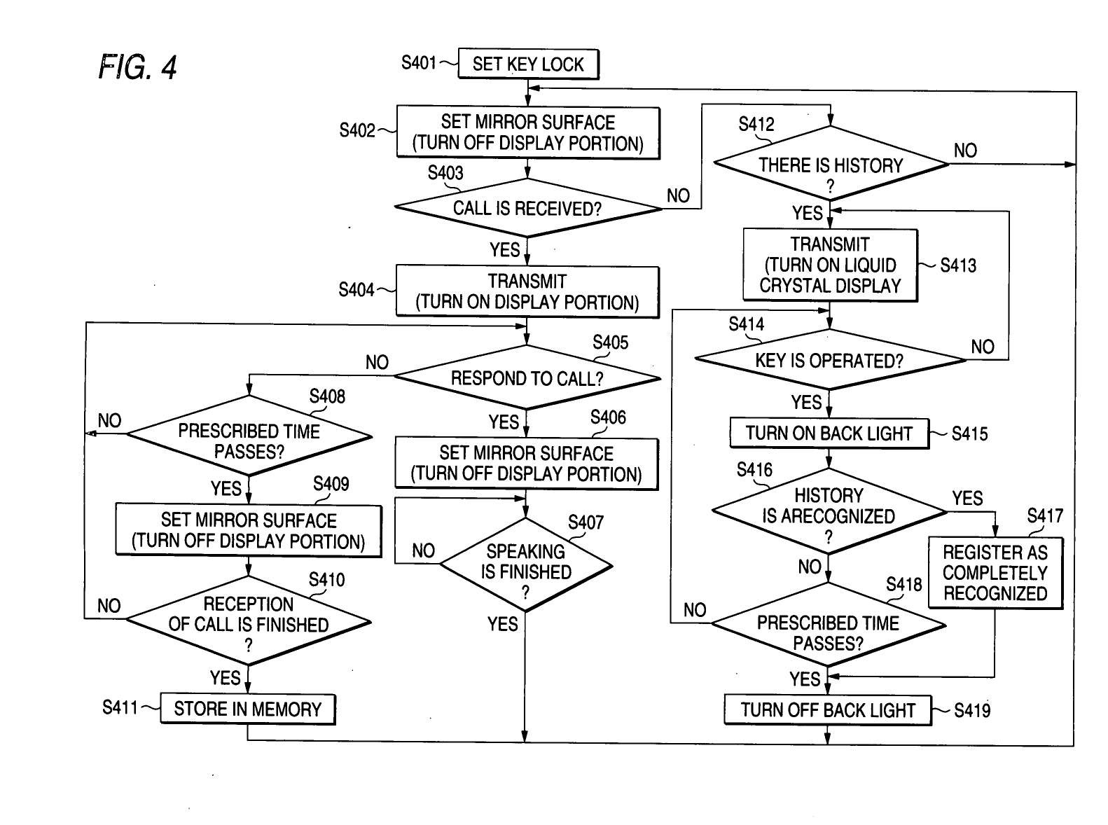

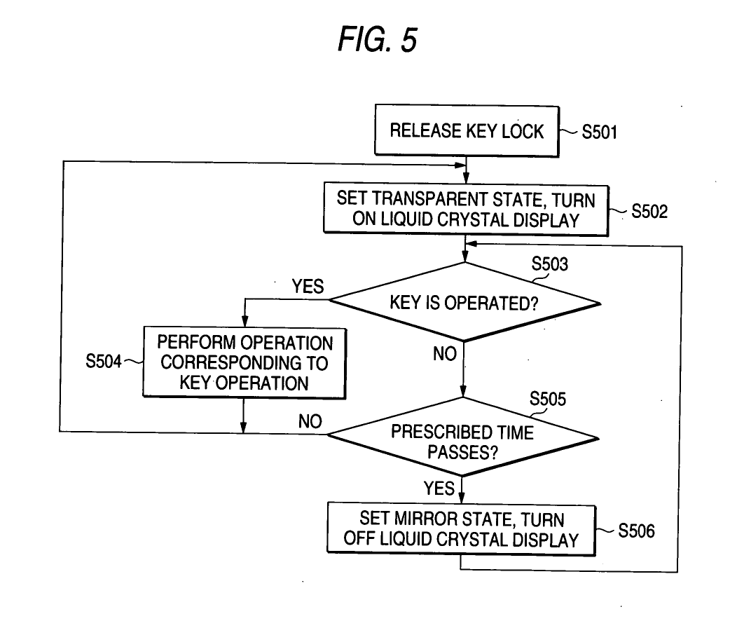

FIG. 1 is a schematic block diagram of a portable telephone according to an embodiment of the present invention. FIG. 2 is a view of an external appearance of the portable telephone. FIG. 3 is a sectional view taken along a line A-A of a display portion and a panel part of the portable telephone shown in FIG. 2. FIGS. 4 and 5 are flow charts for explaining the operations of the portable telephone.

In FIGS. 1 and 2, a portable telephone 100 according to the embodiment includes an antenna 1, a transmitting and receiving part 2 for transmitting and receiving information through the antenna 1, a key operating part 3 configured by a plurality of keys for inputting telephone numbers, characters, instructions, etc., a speaker 4 for generating a call receiving sound, a speaking voice or the like, a microphone 5 used during speaking, a receiver 6, a memory 7 for storing various kinds of programs and various kinds of data, etc., a panel control part 9 for controlling a below-described panel 8, a display portion 10 composed of a liquid crystal display portion for performing various kinds of displays, a display portion control part 11 for controlling the display portion 10 and a central control part 12 for controlling these parts respectively.

In the portable telephone 100, when the key operating part 3 is operated to input the telephone number of a mate, the telephone number of the mate is displayed on the display portion. Under this state, when the key operating part is further used to perform a transmitting operation, the mate can be called by telephone. Further, in the memory 7, the name and the telephone number of the mate can be stored as a telephone directory. When the name and the telephone number of the mate are stored in the memory, the name of the mate is inputted to call the telephone number so that a transmitting operation can be performed.

Then, when a call is received, the call receiving sound is outputted from the speaker 4. When the telephone number of the mate is transmitted from the mate side (a central office side), the telephone number is displayed on the display portion 10. Further, when the name and the telephone number of the mate are stored in the memory 7, the transmitted telephone number of the mate is compared with the telephone number stored in the memory 7. When the telephone number coincides with the telephone number stored in the memory, the name of the mate corresponding to the coinciding telephone number is also displayed on the display portion 10 at the same time.

When a call is received and the key operating part 3 is operated to respond to the received call, the microphone 5 and the receiver 6 are used so that a user can talk with the mate.

Then, either when the user responds to the received call to speak to the mate or when the user himself or herself transmits a call to the mate to speak to the mate, if the user can speak to the mate, the central control part 12 properly counts a speaking time or a speaking charge to display the counted speaking time and the speaking charge on the display portion 10. Further, when the key operating part 3 is operated so that the user can speak to the mate under a hands-free state, the user can speak to the mate under the hands-free state by using the microphone 5 or the speaker 4.

Further, the portable telephone 100 includes functions of a mail, internet, a game, a clock, a calculator, etc. as well as a function as the telephone. These functions can respectively operate through a key input by the key operating part 3.

Further, when a predetermined time passes without operating the key operating part 3, this is detected by the central control part 12. In the portable telephone 100, a unit is provided for turning off a back light for lighting the display portion 10 from a back under the control of the central control part 12. However, when the key operating part 3 is operated, the back light is turned on again. Thus, to avoid the exhaustion of a battery by unexpectedly performing a key operation, what is called a key lockup state can be set in which the keys cannot be operated under an operation other than a predetermined specific key operation or under a condition other than a specific condition.

The display portion 10 is configured by a liquid display portion 10a, as described above. As shown in FIG. 3, on the back surface (an opposite surface to a display surface) of the liquid crystal display portion 10a, a light guide plate 10b for guiding light from the back light 10c to the back surface of the liquid crystal display portion 10a is arranged. On the front surface (the display surface) of the display portion 10, the panel 8 is arranged. The panel 8 includes a liquid crystal material 8a, transparent electrodes 8b and 8c for applying voltage to the liquid crystal material 8a, a deflecting plate 8d disposed in the front side of the liquid crystal material 8a and a reflection type deflecting plate 8e disposed in the back side of the liquid crystal material 8a.

The panel 8 is formed in such a way that the orientation of a liquid crystal is changed depending on the voltage applied to the transparent electrodes 8b and 8c and an aperture is changed in accordance with the relation between the deflecting plates 8d and 8e. As a result, under a state (a state that a power is turned off) that the voltage is not applied between the transparent electrodes 8b and 8c, the aperture becomes maximum so that external lights and lights from the display portion 10 side are substantially completely transmitted. On the other hands, under a state that voltage is applied between the transparent electrodes 8b and 8c (a state that a power is turned on), the aperture becomes minimum so that the lights from the display portion 10 are not transmitted and the external lights are reflected. Accordingly, the panel operates to be brought to what is called a mirror surface state or a state similar thereto.

As described above, in the portable telephone 100, the panel 8 that is brought to the mirror surface state when the voltage is applied thereto and to a transparent state when the voltage is not applied thereto is provided in the front surface (the display surface side) of the display portion 10. Then, the panel 8 and the display portion 10 respectively operate as shown in FIGS. 4 and 5 in a key locked state or in an ordinary state that the key locked state is released.

As shown in FIG. 4, when the key operating part 3 is used to operate a preset key and set the key locked state (step 401), this state is detected by the central control part 12. The central control part 12 controls the panel control part 9 to apply prescribed voltage to the panel 8. Accordingly, under this state, the panel 8 is brought to the mirror surface state. At the same time, in the display portion 10, a display is turned off under the control of the central control part 12 and the display portion control part 11 and the back light 10c is also turned off (step 402).

That is, in the key locked state, since the panel 8 is in the mirror surface state and the display portion 10 cannot be seen through, the display portion 10 and the back light 10c can be turned off. Electric power required in a display part is only the voltage applied to the panel 8. Consumed electric power can be extremely reduced as compared with that when the display portion 10 and the back light 10c are turned on. Under this state, since the panel 8 is located in the mirror surface state, the panel 8 can be directly used as a mirror and can be effectively utilized for dressing or other uses.

In the key locked state, even when keys are operated without the specific key operation or the key operation under the specific conditions, the central control part 12 decides these key operations to be invalid and make them inoperative. Here, as the specific conditions, a case that a call is received or a case that unrecognized call receiving history information or a mail is received or the like is set in the portable telephone 100. In these cases, the key operations are respectively decided to be valid as described below so that a prescribed operation can be carried out.

Now, this operation will be described below in detail.

Firstly, the central control part 12 always monitors whether or not a call is received even under the key locked state (step 403). When the call is received, the central control part 12 detects it and controls the panel control part 9 to stop the supply of power to the panel 8 and bring the panel 8 to a transparent state. At the same time, the central control part 12 controls the display portion control part 11 to display the name and the telephone number of the mate who sends the call on the display portion 10 (step 404). Then, if the back light 10c is necessary, the central control part controls the back light to be lighted at the same time, brightly light the display portion 10 from its back surface and further emit a calling sound from the speaker 4.

When the user hears the calling sound or sees the display of the display portion 10 to respond to the received call by operating a responding key (Y of step 405), the central control part 12 detects the key operation as the key operation under the specific conditions and controls the panel control part 9 to bring the panel 8 to the mirror surface state. Then, the display portion 10 is turned off and the back light 10c is also turned off (step 406). During speaking, this state is maintained. When the speaking is finished (Y of step 407), the central control part returns to an original key locked state (step 402).

On the other hand, when the call is received and the panel 8 is brought to the transparent state (step 404) and the user does not respond to the received call (N of step 405), the central control part 12 decides whether or not a prescribed time passes after the call is received (step 408). When the prescribed time does not pass, the central control part returns to the step (step 405) for deciding whether or not the user responds to the received call to repeat this state. When the prescribed time passes while the user does not respond to the received call, the central control part 12 detects it and controls the panel control part 9 or the display portion control part 11 to bring the panel 8 to the mirror surface state and turn off the display portion 10 and the back light 10c (step 409). Then, the central control part 12 decides whether or not the user is receiving the call (step 410). When the user is receiving the call, the central control part operates to continuously decide whether or not the user responds to the call (step 405). When the user completely receives the call, the central control part temporarily stores the telephone number of the mate in the memory 7 as the unrecognized call receiving history information (step 411) and returns to the original key locked state (step 402).

Even when there is no call under the key locked state (N of step 403), the central control part 12 constantly monitors whether or not there is unrecognized call receiving history information or a receiving mail (step 412). When there is the unrecognized call receiving history information or the receiving mail, the central control part controls the panel control part 9 or the display portion control part 11 respectively to bring the panel 8 to the transparent state and turn on the display of the display portion (step 413). Then, in this case, to reduce the consumption of electric power, the back light 10c is turned off. In the display portion 10, the display can be seen through the panel 8 due to the brightness of itself.

Subsequently, under this state, when the keys are operated to recognize the unrecognized call receiving history information or the receiving mail (Y of step 414), the central control part 12 detects it to turn on the back light 10c (step 415). Accordingly, under this state, the display portion 10 is lighted brightly so that the unrecognized call receiving history information or the receiving mail can be assuredly and visually recognized.

To recognize the unrecognized call receiving history information or the receiving mail, some key operations need to be carried out. Under the state that the unrecognized call receiving history information or the receiving mail is recognized, as long as the key operations are carried out, the panel 8, the display portion 10 and the back light 10c maintain their states (the state of step 415) as they are for a predetermined time after the key operations are carried out.

Accordingly, while the unrecognized call receiving history information or the receiving mail is recognized, the display portion 10 is brightly lighted by the back light 10c so that the display of the display portion 10 can be precisely and visually recognized through the panel 8.

When the recognition of the unrecognized call receiving history information or the receiving mail is finished, the central control part 12 detects it. The recognized call receiving history information or the receiving mail is registered in the memory 7 as the recognition finished call receiving history information or the receiving mail (step 417). Then, the central control part turns off the back light 10c (step 419) and returns to that original key locked state (step 402).

When, although there is the unrecognized call receiving history information or the receiving mail, it is not recognized and left (N of step 414), the states that the panel 8 is located in the transparent state, the display portion 10 is turned on and the back light 10c is turned off (step 413) are maintained. When a call is not received and there is not the unrecognized call receiving history information or the receiving mail, the central control part directly returns to the original key locked state (step 402) to continuously decide whether or not a call is received or whether or not there is the unrecognized call receiving history information or the receiving mail (step 403, step 412).

The operation when the key locked state is set is described above. The key locked state can be released by operating a specific key. Now, the detail of an operation when the key locked state is released will be described below.

As shown in FIG. 5, when a specific key operation (for instance, an exclusive key is operated, a common key is pressed for a long time, or specific operations are carried out such as operations in specific order) is carried out to release the key locked state (step 501), the central control part 12 detects it. The central control part 12 controls the panel control part 9 or the display portion control part 11 to bring the panel 8 to the transparent state and turn on the display portion 10 and the back light 10c, respectively (step 502).

Then, under this state, the central control part 12 always monitors whether or not any key except a key for setting the key locked state is operated (step 503). When any key is operated, an operation corresponding to the key operation is performed (step 504). When the key operation is not carried out and a preset time passes (Y of step 505), the central control part 12 detects it and controls the panel control part 9 or the display portion control part 11 to bring the panel 8 to the mirror surface state and turn off the display portion 10 and the back light 10c (step 506). Then, under this state, the central control part returns to the state for deciding whether or not any key is operated (step 503).

As described above, according to this embodiment, the panel 8 is provided in the display surface side of the display portion 10. The panel 8 is brought to the mirror surface state under the key locked state. Even under the key locked state, when the call is received, the panel 8 is brought to the transparent state. When the user responds to the call, the panel 8 is immediately brought to the mirror surface state. Under the mirror surface state, since the display portion 10 cannot be seen through, both the display portion 10 and the back light 10c can be turned off. Under this state, the consumption of electric power can be reduced.

Further, according to this embodiment, even under the key locked state, when the call is received, the panel 8 is brought to the transparent state and the display portion 10 and the back light 10c are turned on under this state. Thus, the name and the telephone number of the mate who sends the call that are displayed on the display portion 10 can be clearly and visually recognized through the panel 8.

Further, according to this embodiment, when there is the unrecognized call receiving history information or the receiving mail, the panel 8 is brought to the transparent state to recognize it. After the unrecognized call receiving history information or the receiving mail is recognized, the recognized call receiving history information or the receiving mail is determined to be completely recognized to return the panel 8 and the display portion 10 to original states (the panel 8 is brought to the mirror surface state, the display portion 10 is turned off and the back light 10c is turned off). Thus, whether or not there is the unrecognized call receiving history information or the receiving mail can be easily recognized.

In this embodiment, as the display portion 10, the liquid crystal display portion 10a that does not emit light by itself is used and the liquid crystal display portion 10a is suitably lighted by the back light 10c. However, the back light 10c may be completely synchronized with turning on/off of the liquid crystal display portion 10a. Further, even when a display portion that emits light by itself is used as the display portion 10, electric power supplied to the display portion 10 is similarly suitably and stepwise controlled or on/off controlled to obtain the same effects.

The present invention is described in detail by referring to the specific embodiment. However, it is to be understood to a person with ordinary skill in the art that various changes or modifications may be applied thereto without departing the spirit and the scope of the present invention.

This application is based on Japanese Patent Application No. 2002-178787 filed on Jun. 19, 2002 and the contents thereof are incorporated herein as a reference.

### INDUSTRIAL APPLICABILITY

As described above, according to the present invention, the panel located in the display surface side of the display portion can be brought to the mirror surface state under the key locked state. Under this state, the panel can be used as a mirror for dressing or other uses. In the display portion, since the display is turned off, excessive electric power does not advantageously need to be consumed.

1. A telephone, comprising:
a display portion;
a panel, which is provided on a display surface side of the display portion, and which changes from a transparent state to a mirror surface state when voltage is applied to the panel; and
a control unit, which brings the panel to the mirror surface state and turns off the power of the display portion when a key locked state is set.

2. The telephone as set forth in claim 1, further comprising a second control unit which brings the panel to the transparent state and turns on the power of the display portion when a call is received under the key locked state.

3. The telephone as set forth in claim 2, further comprising a third control unit which brings the panel to the mirror surface state and turns off the power of the display portion when a response to the received call is performed.

4. The telephone as set forth in claim 1, wherein the second control unit is provided for bringing the panel to the transparent state and turning on the power of the display portion when there is unrecognized call receiving history information or an unrecognized receiving mail under the key locked state.

5. The telephone as set forth in claim 4, wherein the third control unit is provided for bringing the panel to the mirror surface state and turning off the power of the display portion when a recognition of the unrecognized call receiving history information or the unrecognized receiving mail is performed.
